(19) United States
(12) Patent Application Publication
(10) Pub. No.: US 2009/0019902 A1
(43) Pub. Date: Jan. 22, 2009

(54) VEHICLE ANTI-THEFT DEVICE

(76) Inventor: Richard Baranek, Petach Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/162,805

(22) PCT Filed: Feb. 1, 2007
(86) PCT No.: PCT/IL07/00126

§ 371 Date: Jul. 31, 2008

Related U.S. Application Data
(60) Provisional application No. 60/764,327, filed on Feb. 2, 2006.

(51) Int. Cl. E05B 65/12

(52) U.S. Cl. 70/237

(57) ABSTRACT

Disclosed are a number of novel features. Among them are configuring the casing of the present invention such that once deployed an attempted forced or unauthorized removal of the casing from the vehicle will render the vital vehicle component encased by the casing inoperable. This inoperability may include, but is not limited to, detaching from the vital vehicle component at least one wire extending from the vital vehicle component. Alternatively, the casing may be fabricated from a material with a relatively low melting point and the casing may be deployed such that an attempted unauthorized removal using a cutting torch will cause portions of the casing to melt such that molten casing material will fall onto and damage the vital vehicle component and render it inoperable. Another feature is that of configuring the casing from a material having a first set of material properties and attaching the casing element one to another using connectors having a second set of material properties. The material properties of the casing include a low melting point and the material properties of the connectors include a hardness such that friction between a connector and a rotating portion of a tool, such as but not limited to a drill bit or a grinder wheel, causes the temperature of the connector to exceed the low melting point of the casing material. Thusly configured, during an attempted unauthorized removal of any one of the connectors using a tool having a rotating portion, the anti-theft characteristics of the anti-theft device of the present invention are enhanced by the welding of the connector to at least one of the interconnecting elements of the casing.

### FIELD AND BACKGROUND OF THE INVENTION

The present invention relates to vehicle anti-theft devices that encase strategic vehicle components and, in particular, it concerns a vehicle anti-theft casing having components fabricated from different materials such that an interaction between the different materials during an attempted unauthorized removal enhances the tamper resistance of the device.

It is known to encase critical vehicle components so as to limit or obstruct access in order to deter thieves. Traditionally, the encasing devices are constructed with parts made from the hardest materials available, such as case hardened steel or cast iron. A drawback associated with these types of devices is that modern technology has provided thieves with better tools with which to forcibly remove them, such as portable high performance cutting torches, high speed drills, grinders and the like.

One response to modern tools in an attempt to slow thieves down in order to allow detection by passers-by or the police is disclosed in UK Patent Application No. GB 2 250 493 A. GB 2 250 493 A relates to a protective housing of a deformable, non-brittle material that encases the components of a conventional steering lock/ignition assembly. Disclosed is a device in which “ . . . removal of the device . . . is made a difficult task to deter a potential thief for attempting to do so. For example, the nuts and bolts are preferably glued together and the heads of the nuts are preferably filled with epoxy resin or the like . . . ” and “ . . . the material of the device is chosen to be of a plastic nature and is preferably mild steel, stainless steel of a like non-brittle material which deforms rather than crack on the application of substantial physical stresses.”

Nowhere in the prior art is found a discussion of a casing having components fabricated from different materials, an interaction between which enhances the tamper resistance of the device.

There is therefore a need for a vehicle anti-theft casing having components fabricated from different materials such that an interaction between the different materials during an attempted unauthorized removal enhances the tamper resistance of the device.

### SUMMARY OF THE INVENTION

The present invention is a vehicle anti-theft casing having components fabricated from different materials such that an interaction between the different materials during an attempted unauthorized removal enhances the tamper resistance of the device.

According to the teachings of the present invention there is provided, a vehicle anti-theft device for encasing vital vehicle components, the vehicle anti-theft device comprising a casing configured such that attempted unauthorized removal of the casing causes an enhancement of anti-theft characteristics of the vehicle anti-theft device.

According to a further teaching of the present invention, the casing is configured such that the attempted unauthorized removal of the casing renders inoperable at least one of the vital vehicle components the casing encases.

According to a further teaching of the present invention, the casing is interconnected to at least one wire extending from at least one of the vital vehicle components such that the unauthorized removal detaches the at least one wire from the at least one of the vital vehicle components.

According to a further teaching of the present invention, the casing is configured such that the unauthorized removal causes the casing to melt and molten casing material damages at least one of the vital vehicle components so as to render the at least one of the vital vehicle components inoperable.

According to a further teaching of the present invention, there is also provided, a) the casing having at least two interconnecting elements, the casing being fabricated from a material having a first set of material properties; and b) a plurality of connectors configured to attach the at least two interconnecting casing elements one to another, the connectors being fabricated from a material having a second set of material properties, wherein an interaction between the casing and at least one of the plurality of connectors during an attempted unauthorized removal of the at least one of the plurality of connectors enhances the attachment of the at least two interconnecting casing elements one to another.

According to a further teaching of the present invention, the connectors are shear-bolts configured such that a head portion of the shear-bolt detaches from a shaft portion of the shear-bolt when a predetermined torque force is reached during the attachment of the at least two interconnecting casing elements one to another.

According to a further teaching of the present invention, the first set of material properties of the casing includes a low melting point and the second set of material properties includes a hardness such that friction between the connector and a rotating portion of a tool causes a temperature of the connector to exceed the low melting point of the casing material such that during the attempted unauthorized removal of the at least one of the plurality of connectors by use of a tool with a rotating portion, the enhancement of anti-theft characteristics includes a welding of the at least one of the plurality of connectors to at least one of the at least two interconnecting elements of the casing.

There is also provided according to the teachings of the present invention, a method for preventing the theft of a vehicle, the method comprising encasing at least one vital vehicle component with a vehicle anti-theft device having a casing configured such that an attempted unauthorized removal of the casing causes an enhancement of anti-theft characteristics of the vehicle anti-theft device.

According to a further teaching of the present invention, there is also provided deploying the casing such that the attempted unauthorized removal of the casing renders inoperable the at least one of the vital vehicle component.

According to a further teaching of the present invention, the deployment is implemented such that the casing is interconnected to at least one wire extending from the at least one vital vehicle component such that the attempted unauthorized removal detaches the at least one wire from the at least one vital vehicle component.

According to a further teaching of the present invention, there is also provided a) fabricating the casing such that the attempted unauthorized removal causes the casing to melt; and b) deploying the casing such that upon the attempted unauthorized removal, molten casing material damages the at least one vital vehicle component so as to render the at least one vital vehicle component inoperable.

According to a further teaching of the present invention, there is also provided a) fabricating the casing so as to have at least two interconnecting elements, the casing being fabricated from a material having a first set of material properties; and b) providing a plurality of connectors configured to attach the at least two interconnecting casing elements one to another, the connectors being fabricated from a material having a second set of material properties, wherein an interaction between the casing and at least one of the plurality of connectors during the attempted unauthorized removal of the at least one of the plurality of connectors enhances the attachment of the at least two interconnecting casing elements one to another.

According to a further teaching of the present invention, the connectors are implemented as shear-bolts configured such that a head portion of the shear-bolt detaches from a shaft portion of the shear-bolt when a predetermined torque force is reached during the attachment of the at least two interconnecting casing elements one to another.

According to a further teaching of the present invention, the casing is implemented such that the first set of material properties includes a low melting point and the plurality of connectors are implemented such that the second set of material properties includes a hardness such that friction between the at least one connector and a rotating portion of a tool causes a temperature of the connector to exceed the low melting point of the casing material such that during the attempted unauthorized removal of the at least one of the plurality of connectors by use of a tool having a rotating portion, the enhancement of anti-theft characteristics includes a welding of the at least one of the plurality of connectors to at least one of the at least two interconnecting elements of the casing.

### BRIEF DESCRIPTION OF THE DRAWINGS

The invention is herein described, by way of example only, with reference to the accompanying drawings, wherein:

FIG. 1 is a front isometric view of a first preferred embodiment of a vehicle anti-theft casing constructed and operational according to the teachings of the present invention;

FIG. 2 is a rear isometric view of the embodiment of FIG. 1;

FIG. 3 is a side view of an outer section of the vehicle anti-theft casing of the embodiment of FIG. 1;

FIG. 3A is an end view of outer section of FIG. 3, along section line A-A;

FIG. 4 is a bottom view of a second preferred embodiment of a vehicle anti-theft casing constructed and operational according to the teachings of the present invention; and

FIG. 5 is a side view of a shear-bolt constructed and operational according to the teachings of the present invention.

### DESCRIPTION OF THE PREFERRED EMBODIMENTS

The present invention is a vehicle anti-theft casing having components fabricated from different materials such that an interaction between the different materials during an attempted unauthorized removal enhances the tamper resistance of the device.

The principles and operation of a vehicle anti-theft casing according to the present invention may be better understood with reference to the drawings and the accompanying description.

By way of introduction, the present invention includes a number of novel features, among them are configuring the casing of the present invention such that once deployed an attempted forced or unauthorized removal of the casing from the vehicle will render the vital vehicle component encased by the casing inoperable. This inoperability may include, but is not limited to, detaching from the vital vehicle component at least one wire, or other element, extending from the vital vehicle component. Alternatively, the casing may be fabricated from a material with a relatively low melting point and the casing may be deployed such that an attempted unauthorized removal using a cutting torch will cause portions of the casing to melt such that molten casing material will fall onto and damage the vital vehicle component and render it inoperable. It will be understood that the term “vital vehicle component” is used herein to make non-limiting reference to substantially any vehicle component that once disabled will render the vehicle inoperable, and preferably a component that once disabled will require servicing beyond that which is available “road side” in order to restore functionality. Such vital vehicle components may include, but are not limited to, starters, starter solenoids, distributors, fuel pumps, vehicle on-board computer components such as the Electronic Engine Management Unit or the Vehicle Systems Control Unit.

Another feature discussed herein is that of configuring the casing from a material having a first set of material properties and attaching the casing element one to another using connectors having a second set of material properties. The material properties of the casing include a low melting point and the material properties of the connectors include a hardness such that friction between a connector and a rotating portion of a tool, such as but not limited to a drill bit or a grinder wheel, causes the temperature of the connector to exceed the low melting point of the casing material. Thusly configured, during an attempted unauthorized removal of any one of the connectors using a tool having a rotating portion, the anti-theft characteristics of the anti-theft device of the present invention are enhanced by the welding of the connector to at least one of the interconnecting elements of the casing. It should be noted that the term “enhance” and all of its grammatical variations are used here in reference to an improvement of the anti-theft characteristics of the devise of the present invention. It will be appreciated that the examples of “enhancement” discussed herein are indeed intended to be examples and are not intended to limit the scope of the present invention as other enhancements may be possible within the scope of the present invention.

It will be appreciated that the size and shape of the anti-theft casing of the present invention will be determined by the particular vehicle and the specific vital vehicle component to be encased. That is, the make and model of the vehicle as well as the shape and location of the vital vehicle component are factors in determining the size and shape of the anti-theft casing.

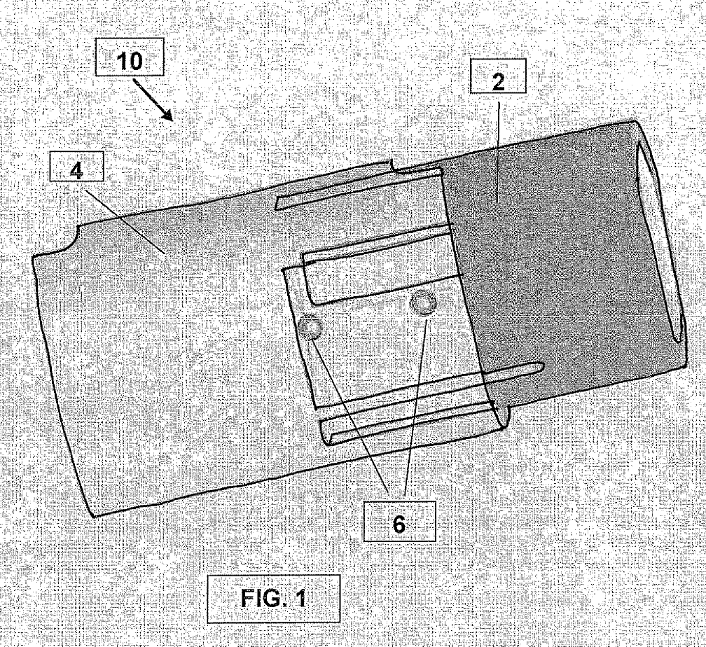

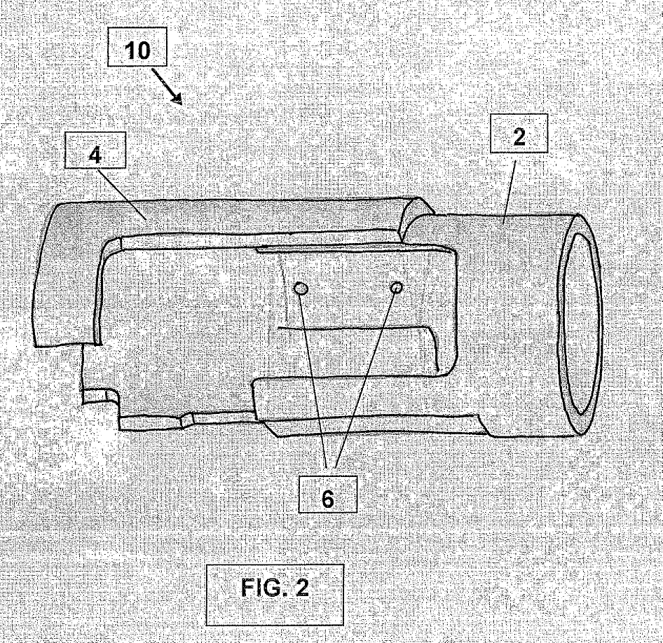

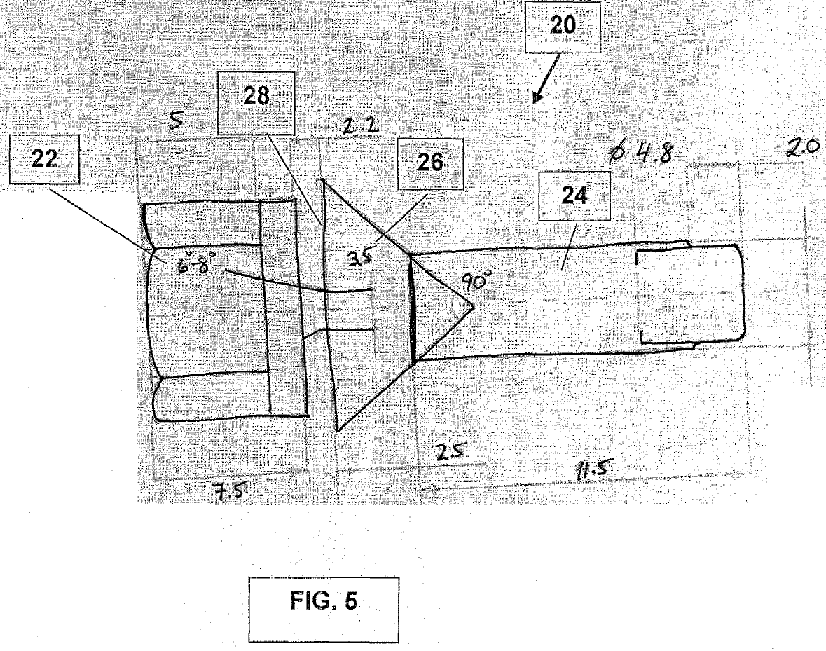

Referring now to drawings, FIGS. 1 and 2 illustrate a first preferred embodiment of a vehicle anti-theft casing, generally referred to herein by reference numeral 10. This embodiment is specifically designed to encase a started solenoid and is included here as a non-limiting example of a substantially cylindrical casing. As shown here, during deployment of the casing, a portion of the inner section 2 of the casing is inserted into the outer section 4 of the casing so as to encase the started solenoid (not shown). The inner section 2 of the casing and the outer section 4 of the casing are then fixedly attached one to another using shear-bolts that are screwed into threaded bolt holes 6. A non-limiting example of a shear-bolt 20 according to the present invention is illustrated in FIG. 5.

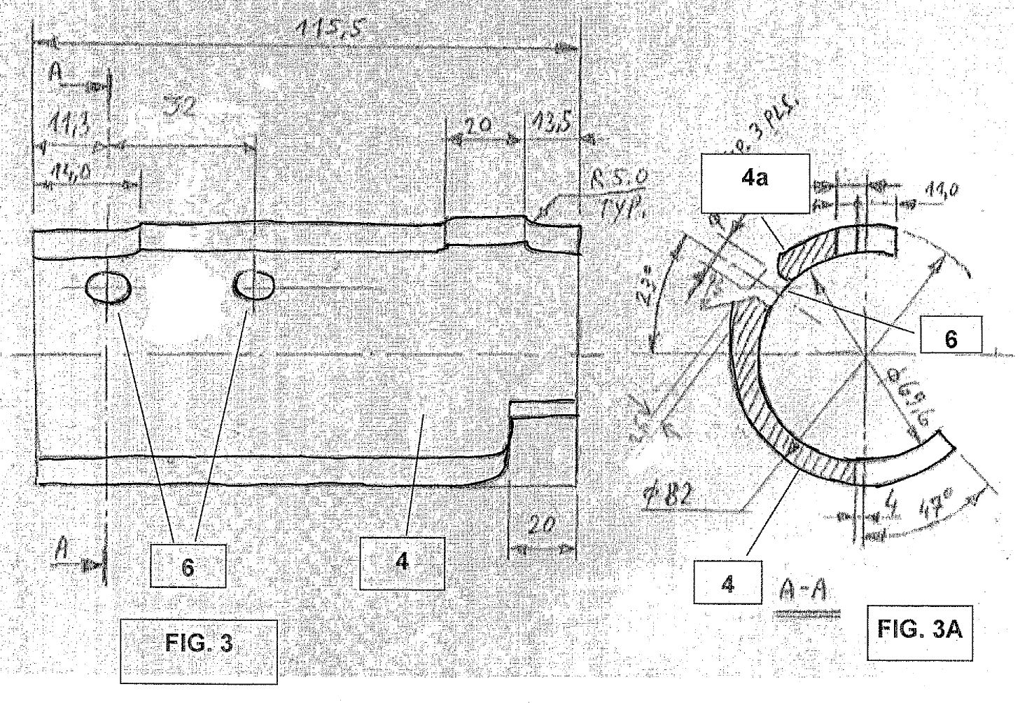

FIGS. 3 and 3A illustrate the outer section 4 of the anti-theft casing of the present invention. When fixedly attaching the inner section 2 of the casing and the outer section 4 of the casing one to another using the shear-bolt of FIG. 5, the drive head portion 22 of the shear-bolt detaches from the retainer portion 24 of the shear-bolt when a predetermined torque is reached. Once the drive head portion 22 is detached from the retainer portion 24, the end surface 28 of the retainer head 26 is substantially flush with the outer surface 4a of the outer section 4 of the casing. In such a deployment, removal of the retainer portion 24 of the shear-bolt may be achieved only by drilling or cutting of the bolts or the casing.

In a first variation of this first preferred embodiment of the present invention, one or more wires (not shown) extending from the starter solenoid (not shown) is attached to the inside of one or both of the casing sections 2 and 4 during installation of the casing such that a forced removal of the casing results in detaching the wire or wires from the starter solenoid.

In a second variation of this first preferred embodiment of the present invention, either one or both of the outer casing section 4 and the inner casing section 2 may be fabricated from a material with a relatively low melting point such as, but not limited to, aluminum or aluminum alloy. The casing may be deployed such that an attempted unauthorized removal using a cutting torch or a grinder will raise the temperature of areas of the casing so as to cause the casing material to melt such that molten casing material will fall onto and damage the starter solenoid and render it inoperable.

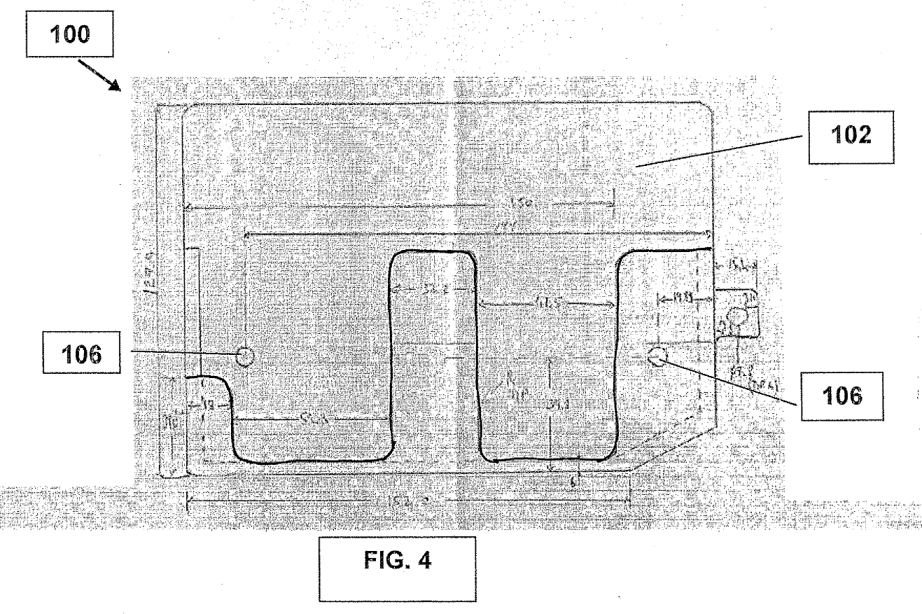

FIG. 4 illustrates a second preferred embodiment of a vehicle anti-theft casing, generally referred to herein by reference numeral 100. This embodiment is specifically designed to encase a Vehicle Systems Control Unit and is included here as a non-limiting example of a substantially rectangular box type casing. As shown here, during deployment of the casing, a portion of the top section 102 of the casing is interconnected to the bottom section (not shown) of the casing so as to encase the Vehicle Systems Control Unit (not shown). The top section 102 of the casing and the bottom section of the casing are then fixedly attached one to another using shear-bolts that are screwed into threaded bolt holes 106. A non-limiting example of a shear-bolt 20 according to the present invention is illustrated in FIG. 5.

When fixedly attaching the top section 102 of the casing and the bottom section of the casing one to another using the shear-bolt of FIG. 5, the drive head portion 22 of the shear-bolt detaches from the retainer portion 24 of the shear-bolt when a predetermined torque is reached. Once the drive head portion 22 is detached from the retainer portion 24, the end surface 28 of the retainer head 26 is substantially flush, or coplanar, with the outer surface of the top section 102 of the casing. In such a deployment, removal of the retainer portion 24 of the shear-bolt may be achieved only by drilling or cutting of the bolts or the casing.

In a first variation of this second preferred embodiment of the present invention, one or more wires extending from the Vehicle Systems Control Unit is attached to the inside of one or both of the casing sections during installation of the casing such that a forced removal of the casing results in detaching the wire or wires from the Vehicle Systems Control Unit.

In a second variation of this second preferred embodiment of the present invention, either one or both of the bottom casing section and the top casing section 102 may be fabricated from a material with a relatively low melting point such as, but not limited to, aluminum or aluminum alloy. The casing may be deployed such that an attempted unauthorized removal using a cutting torch or a grinder will raise the temperature of areas of the casing so as to cause the casing material to melt such that molten casing material will fall onto and damage the Vehicle Systems Control Unit and render it inoperable.

It is preferable that once a vital component is disabled or rendered inoperable, it will require servicing beyond that which is available “road side” in order to restore functionality of the vital component and thereby the normal operation of the vehicle.

In yet another variation of any of the preferred embodiment of the present invention, either one or both of the casing sections is fabricated from a material having a first set of material properties that includes, but is not limited to, a melting point that is lower than that of the connectors (bolts) used to attach the two casing sections. The casing element are attached one to another using connectors having a second set of material properties that includes, but is not limited to, a level of hardness such that friction between the connector and a rotating portion of a tool will raise the temperature of the connector above the melting point of the casing material sufficiently to result in the welding of the connector to the casing. Non-limiting examples of a rotating portion of a tool that will create sufficient friction is, but is not limited to, a drill bit or a grinder wheel. Thusly configured, during an attempted unauthorized removal of any one of the connectors using a tool having a rotating portion, the anti-theft characteristics of the anti-theft device of the present invention are changed, and thereby enhanced by the interaction of the two different materials. In this non-limiting example, the enhancement is the welding of the connector to at least one of the interconnecting elements of the casing.

It will be appreciated that the above descriptions are intended only to serve as examples and that many other embodiments and the encasement of many other vital components is possible within the spirit and the scope of the present invention.

What is claimed is:

1. A vehicle anti-theft device for encasing vital vehicle components, the vehicle anti-theft device comprising a casing configured such that attempted unauthorized removal of said casing causes an enhancement of anti-theft characteristics of the vehicle anti-theft device.

2. The vehicle anti-theft device of claim 1, wherein said casing is configured such that said attempted unauthorized removal of said casing renders inoperable at least one of the vital vehicle components said casing encases.

3. The vehicle anti-theft device of claim 2, wherein said casing is interconnected to at least one wire extending from at least one of the vital vehicle components such that said unauthorized removal detaches said at least one wire from the at least one of the vital vehicle components.

4. The vehicle anti-theft device of claim 2, wherein said casing is configured such that said unauthorized removal causes said casing to melt and molten casing material damages at least one of the vital vehicle components so as to render the at least one of the vital vehicle components inoperable.

5. The vehicle anti-theft device of claim 1, further including:
(a) said casing having at least two interconnecting elements, said casing being fabricated from a material having a first set of material properties; and
(b) a plurality of connectors configured to attach said at least two interconnecting casing elements one to another, said connectors being fabricated from a material having a second set of material properties;
wherein an interaction between said casing and at least one of said plurality of connectors during an attempted unauthorized removal of said at least one of said plurality of connectors enhances said attachment of said at least two interconnecting casing elements one to another.

6. The vehicle anti-theft device of claim 5, wherein said connectors are shear-bolts configured such that a head portion of said shear-bolt detaches from a shaft portion of said shear-bolt when a predetermined torque force is reached during said attachment of said at least two interconnecting casing elements one to another.

7. The vehicle anti-theft device of claim 5, wherein said first set of material properties of said casing includes a low melting point and said second set of material properties includes a hardness such that friction between said connector and a rotating portion of a tool causes a temperature of said connector to exceed said low melting point of said casing material such that during said attempted unauthorized removal of said at least one of said plurality of connectors by use of a tool with a rotating portion, said enhancement of anti-theft characteristics includes a welding of said at least one of said plurality of connectors to at least one of said at least two interconnecting elements of said casing.

8. A method for preventing the theft of a vehicle, the method comprising encasing at least one vital vehicle component with a vehicle anti-theft device having a casing configured such that an attempted unauthorized removal of said casing causes an enhancement of anti-theft characteristics of said vehicle anti-theft device.

9. The method of claim 8, further including deploying said casing such that said attempted unauthorized removal of said casing renders inoperable said at least one of the vital vehicle component.

10. The method of claim 9, wherein said deployment is implemented such that said casing is interconnected to at least one wire extending from said at least one vital vehicle component such that said attempted unauthorized removal detaches said at least one wire from said at least one vital vehicle component.

11. The method of claim 9, further including:
(a) fabricating said casing such that said attempted unauthorized removal causes said casing to melt; and
(b) deploying said casing such that upon said attempted unauthorized removal, molten casing material damages said at least one vital vehicle component so as to render said at least one vital vehicle component inoperable.

12. The method of claim 8, further including:
(a) fabricating said casing so as to have at least two interconnecting elements, said casing being fabricated from a material having a first set of material properties; and
(b) providing a plurality of connectors configured to attach said at least two interconnecting casing elements one to another, said connectors being fabricated from a material having a second set of material properties;
wherein an interaction between said casing and at least one of said plurality of connectors during said attempted unauthorized removal of said at least one of said plurality of connectors enhances said attachment of said at least two interconnecting casing elements one to another.

13. The method of claim 12, wherein said connectors are implemented as shear-bolts configured such that a head portion of said shear-bolt detaches from a shaft portion of said shear-bolt when a predetermined torque force is reached during said attachment of said at least two interconnecting casing elements one to another.

14. The method of claim 12, wherein said casing is implemented such that said first set of material properties includes a low melting point and said plurality of connectors are implemented such that said second set of material properties includes a hardness such that friction between said at least one connector and a rotating portion of a tool causes a temperature of said connector to exceed said low melting point of said casing material such that during said attempted unauthorized removal of said at least one of said plurality of connectors by use of a tool having a rotating portion, said enhancement of anti-theft characteristics includes a welding of said at least one of said plurality of connectors to at least one of said at least two interconnecting elements of said casing.
